(19) United States
(12) Patent Application Publication
(10) Pub. No.: US 2010/0216000 A1
(43) Pub. Date: Aug. 26, 2010

(54) METHOD OF PRODUCING ELECTRODE FOR SECONDARY BATTERY AND SECONDARY BATTERY

(76) Inventors: Hideaki Fujita, Osaka (JP); Tsuyoshi Hatanaka, Wakayama (JP); Hidenori Takahashi, Wakayama (JP); Kenichi Nishibata, Wakayama (JP)

Correspondence Address: MCDERMOTT WILL & EMERY LLP, 600 13TH STREET, NW, WASHINGTON, DC, 20005-3096, US

(21) Appl. No.: 12/377,340

(22) PCT Filed: Jul. 9, 2007
(86) PCT No.: PCT/JP2007/063655

§ 371 Date: Feb. 12, 2009

(30) Foreign Application Priority Data
Sep. 19, 2006 (JP) 2006-252068

(51) Int. Cl. H01M 6/10; B29C 65/00; B32B 38/04

(52) U.S. Cl. 429/94; 156/60; 156/250

(57) ABSTRACT

An active material layer 2 is applied on a current collector 1 so as to expose respective end parts of the current collector 1. A first active material layer non-formation part 1a at one of the end parts of the current collector 1 is formed narrower than a second active material layer non-formation part 1b at the other end part thereof. Next, a porous film 3 is formed on the current collector 1 to cover the active material layer 2. In this formation, the porous film 3 covers the edge surface of the active material layer 2 at the first non-formation part 1a while exposing a part of the second non-formation part 1b of the current collector 1.

### TECHNICAL FIELD

The present invention relates to a method for producing a tab-less electrode for a secondary battery and a secondary battery.

### BACKGROUND ART

In general, lithium ion secondary batteries are high in energy density or output density, and can lead to size and weight reduction of appliances. Therefore, application thereof is spreading over from conventional application to power sources for mobile phones and personal computers to further application to power sources for electric power tools and hybrid automobiles requiring further high output. Hence, higher output performance of the secondary batteries are demanded.

In order to implement high output of the lithium ion secondary batteries, the internal resistance of the battery must be minimized. As one of measures therefor, a generally-called tab-less current collection structure has been employed for reducing the current collection resistance of the electrode plates. FIG. 4(a) is a sectional view showing a general structure of a lithium ion secondary battery employing the tab-less structure. As shown in FIG. 4(a), a positive electrode in which a positive electrode active material layer 102 is formed on a positive electrode current collector 101 and a negative electrode in which a negative electrode active material layer 104 is formed on a negative electrode current collector 103, which are wound with a separator 105 interposed therebetween, are accommodated in a battery casing 108. The end parts 101a, 103a of the current collectors 101, 103, on which the active material layers 102, 104 are not formed, are bonded to a positive electrode current collector plate 106 and a negative electrode current collector plate 107, respectively, by welding or the like. Respective bonding of the entire end parts of the positive electrode and the negative electrode to the current collector plates 106, 107 can reduce the current collection resistance of the electrode plates, thereby implementing high output of the lithium ion secondary battery.

The capacity of a lithium ion secondary battery generally depends on the capacity of the positive electrode, and the area of the positive electrode is designed to be smaller than that of the negative electrode, as shown in FIG. 4(b). Referring to the positive electrode as an example, in cutting the positive electrode current collector 10, a conductive burr 111 may be formed at the edge surface of the positive electrode active material layer 102 on the opposite side to the end part 101a of the positive electrode current collector 101 at which the active material layer 102 is not formed, as shown in FIG. 4(c). The burr 111 can push through the separator 105 to be in contact with the opposing negative electrode active material layer 104. This may cause short-circuit between the positive electrode current collector 101 and the negative electrode active material layer 104. Upon short-circuit, the negative electrode active material layer 104, which contains an active material (e.g., graphite) to have a conductivity, allows a high current to flow between itself and the positive electrode current collector 101, thereby inviting heat generation in the battery.

For preventing such internal short-circuit from being caused, Patent Document 1 discloses a technique of forming a heat-resistant porous film on the surface of an active material layer. FIG. 5 is a sectional view showing a structure of an electrode assembly where this technique is employed to the tab-less structure. As shown in FIG. 5, formation of the porous film 120 on the surface of the negative electrode active material layer 104 formed on the negative electrode current collector 103 bars the burr 11 formed at the edge surface of the positive electrode active material layer 102 from pushing through the separator 105 and reaching the negative electrode active material layer 104.

### Patent Document 1: Japanese Unexamined Patent Application Publication 7-220759

### Patent Document 2: Japanese Unexamined Patent Application Publication 9-298058

### Patent Document 3: Japanese Unexamined Patent Application Publication 2004-55537

### DISCLOSURE OF THE INVENTION

### Problems that the Invention is to Solve

It is preferable for securing the battery capacity that the porous film 120 on the negative electrode active material layer 104 is thin as far as possible. For this reason, the porous film 120 is formed by gravure printing or the like (see Patent Document 2, for example).

However, the gravure printing and the like encounters difficulty in forming the porous film 120 on the edge surface of the negative electrode active material layer 140 at the end part of the negative electrode current collector 103 on the opposite side to the exposed part 103a. Accordingly, if the exposed part 101a of the positive electrode current collector 101 is bent by external pressure, it may come in contact with the edge surface of the negative electrode active material layer 104 to invite short-circuit between the positive electrode current collector 101 and the negative electrode active material layer 104.

While, a technique of forming an insulating material on the edge surface of an active material layer is disclosed in Patent Document 3. However, the examples of the insulating material are formed by spray coating of ceramics or attachment of an insulating tape. Therefore, implementation of the technique under excellent control may be difficult, and application of the technique to mass production can involve problems. In addition, the process of forming the porous film on the surface of the active material layer must be carried out separately from the other processes, thereby involving a problem on manufacturing cost.

The present invention has been made in view of the foregoing, and its main objective is to provide a method of producing a highly safety tab-less electrode for a secondary battery, and a secondary battery including a highly safety tab-less electrode.

### Means for Solving the Problems

The inventors took note of the fact that in a tab-less electrode, the exposed part of the current collector on which the active material layer is not formed can serve as a “formation margin” for forming the porous film on the edge surface of the active material layer, and tried positively forming another narrow non-formation part as a “formation margin” for the porous film at the end part of a current collector on the opposite side to the existing non-formation part thereof where an active material layer is not formed (a part to be bonded to a current collector plate) in addition to the existing non-formation part. This enabled formation of the porous film on the edge surface of the active material layer at the non-formation part (formation margin).

A method of producing an electrode for a secondary battery in accordance with the present invention includes: a step (a) of forming an active material layer on a current collector to expose respective end parts of the current collector; and a step (b) of forming a porous film on the current collector to cover the active material layer, wherein, in the step (a), a first active material layer non-formation part at one of the end parts of the current collector is narrower in width than a second active material layer non-formation part at the other end part thereof, and in the step (b), the porous film is formed to cover an edge surface of the active material layer at the first active material layer non-formation part while exposing a part of the second active material layer non-formation part of the current collector.

In the above method, the narrow first non-formation part (formation margin) is formed at one of the end parts of the current collector. This enables formation of the porous film on the edge surface of the active material layer as well as on the surface of the active material layer simultaneously in forming the porous film on the current collector. Hence, a highly safety tab-less electrode can be obtained in which internal short-circuit can be prevented.

Preferably, the porous film is formed to cover the entirety of the first non-formation part. This can minimize the width of the first non-formation part to secure the battery capacity sufficiently.

The porous film is preferably formed by applying a porous film slurry onto the current collector by printing. Hence, a highly safety electrode structure can be attained by such a simplified method.

A secondary battery in accordance with the present invention includes an electrode assembly in which a positive electrode and a negative electrode each composed of a current collector on which an active material layer is formed are wound or stacked with a separator interposed therebetween, wherein a porous film is formed to cover the active material layer on the current collector of at least one of the positive electrode and the negative electrode, the current collector on which the porous film is formed includes at respective ends thereof a first active material layer non-formation part and a second active material layer non-formation part on each of which the active material layer is not formed, the first active material layer non-formation part is narrower in width than the second active material layer non-formation part, an edge surface of the active material layer at the first active material layer non-formation part is covered with the porous film, and a part of the second active material layer non-formation part of the current collector is not covered with the porous film.

In the above arrangement, the porous film covers the edge surface of the active material layer at the narrow first non-formation part formed at one of the end parts of the current collector. Hence, a highly safety secondary battery having a tab-less electrode structure can be obtained in which internal short-circuit can be prevented.

### ADVANTAGES OF THE INVENTION

In the present invention, the narrow first non-formation part (formation margin) is formed at one of the end parts of the current collector to allow the porous film to be formed on the surface and the edge surfaces of the active material layer. Hence, a highly safety tab-less electrode in which internal short-circuit can be prevented, and a secondary battery including it can be provided.

### BRIEF DESCRIPTION OF THE DRAWINGS

FIG. 1 is a sectional view schematically showing an electrode structure of a secondary battery in accordance with an embodiment of the present invention.

FIG. 2(a) to FIG. 2(b) are illustrations showing steps of a method of producing an electrode for a secondary battery in accordance with an embodiment of the present invention.

FIG. 3(a) to FIG. 3(d) are illustrations showing steps of the method of producing an electrode for a secondary battery in accordance with the embodiment of the present invention.

FIG. 4 illustrates a structure of a conventional lithium ion secondary battery, wherein FIG. 4(a) is an overall sectional view of the battery, FIG. 4(b) is a partial sectional view of an electrode assembly, and FIG. 4(c) is a partially enlarged view of a electrode plate.

FIG. 5 is a sectional view showing a structure of a conventional tab-less electrode assembly.

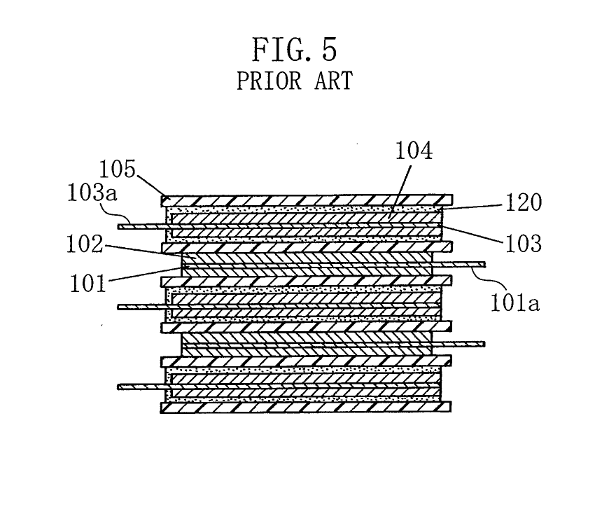

### INDEX OF REFERENCE NUMERALS

1 negative electrode current collector
1a first non-formation part
1b second non-formation part
2 negative electrode active material layer
3 porous film
4 separator
5 positive electrode current collector
5b exposed part
6 positive electrode active material layer
7 gravure roll
8 negative electrode plate
9 liquid tank
10 blade
12 tape
101 positive electrode current collector
101a positive electrode current collector end part
102 positive electrode active material layer
103 negative electrode current collector
103a negative electrode current collector end part
104 negative electrode active material layer
105 separator
106 positive electrode current collector plate
107 negative electrode current collector plate
108 battery casing
111 burr
120 porous film

### BEST MODE FOR CARRYING OUT THE INVENTION

Embodiments of the present invention will be described below with reference to the accompanying drawings. In the drawings mentioned below, the same reference numerals are assigned to elements having substantially the same functions for the sake of simple description. The present invention is not limited to the following embodiments.

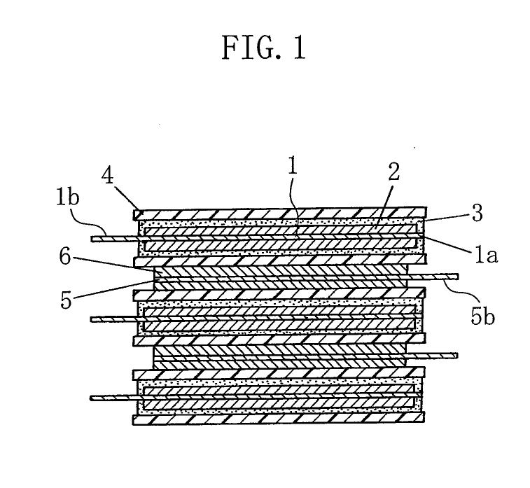

FIG. 1 is a sectional view schematically showing an electrode structure of a secondary battery in accordance with an embodiment of the present invention.

As shown in FIG. 1, an electrode assembly is formed in such a fashion that a negative electrode in which an active material layer 2 is formed on a negative electrode current collector 1, and a positive electrode in which an active material layer 6 is formed on a positive electrode current collector 5 are wound or stacked with a separator 4 interposed therebetween. On the negative electrode current collector 1, a porous film 3 is formed to cover the active material layer 2. The negative electrode current collector 1 covered with the porous film 3 includes at the respective end parts a first active material layer non-formation part 1a and a second active material layer non-formation part 1b on each of which the active material layer 2 is not formed. The first non-formation part 1a is narrower in width than the second non-formation part 1b. The edge surface of the active material layer 2 at the first non-formation part 1a is covered with the porous film 3, while on the other hand a part of the second non-formation part 1b of the negative electrode current collector 1 is not covered with the porous film 3.

In the present embodiment, the surface of the negative electrode active material layer 2 formed on the negative electrode current collector 1 and the edge surfaces thereof at the first non-formation part 1a are covered with the porous film 3. This can prevent internal short-circuit between the positive electrode current collector 5 and the negative electrode active material layer 2, which is caused due to, for example, formation of a burr at an edge surface of the negative electrode active material layer 6, bending by pressing of an exposed part 5b of the positive electrode current collector 5, or the like. Hence, a secondary battery having a highly safety tab-less structure can be realized.

The second non-formation part 1b is to be bonded to a current collector plate connected to an electrode terminal (an external terminal), and is has been formed in a conventional tab-less electrode. On the other hand, the conventional tab-less electrode does not include the first non-formation part 1a. Specifically, in the conventional tab-less electrode, the end part of a current collector on the opposite side to the second non-formation part 1b is cut together with the active material layer formed on the surface thereof, and therefore, the edge surface of the current collector on this side is flash with the edge surface of the active material layer.

In contrast, the first non-formation part 1a in the present invention is a non-formation part which is formed as a “formation margin” for the porous film 3 additionally at the opposite end part to the second non-formation part 1b, and is narrower than the second non-formation part 1b. The porous film 3 may be formed by applying a slurry containing a material of the porous film (hereinafter referred to it as a “porous film slurry”) onto a current collector by printing or the like. In application, the porous film slurry is applied onto the active material layer 2 with the first non-formation part 1a utilized as a “formation margin,” so that the slurry flows onto the associated edge surface of the active material layer. Thus, the porous film 3 can be formed on the edge surfaces of the active material layer 2.

Accordingly, the first non-formation part 1a may have only a minimum width for serving as the “formation margin.” In other words, it is preferable to form the porous film 3 so as to cover the entirety of the first non-formation part 1a. This formation can minimize the width of the first non-formation part 1a, thereby securing the battery capacity sufficiently.

After the active material layer 2 is formed on each surface of the negative electrode current collector 1, the negative electrode current collector 1 is cut with the first non-formation part 1a left. This may result in that the width of the remaining first non-formation part 1a is larger than the minimum width that can serve as the “formation margin” for reason of accuracy of processing or the like. However, no adverse influence thereof is involved on the advantages exhibited in the present invention. For example, setting of the width of the first non-formation part 1a to be equal to or smaller than 3 mm, more preferably, equal to or smaller than 1 mm can realize a highly safety secondary battery in which substantial lowering of the battery capacity can be suppressed. Setting of the width of the second non-formation part 1b to be equal to or larger than 5 mm, for example, can secure bonding by welding or the like thereof to a current collector plate. In addition, allowing the porous film 3 to have a thickness of about 2 to 30 μm (typically 2 to 10 μm) can realize a highly safety secondary battery in which substantial lowering of the battery capacity can be suppressed.

As described above, it is preferable to form the porous film 3 by applying, by printing, a slurry obtained by mixing a material of the porous film with a solvent onto the negative electrode current collector 1 having the surfaces on each of which the active material layer 2 is formed. Example materials of the porous film may include powder inorganic oxide (filler), such as alumina, silica, and the like, for example. As a binder used for allowing the filler to be the porous film 3, a rubber-like high polymer containing a polyacrylonitrile group which is amorphous and has high heat resistance and rubber elasticity, or the like is preferably used, for example. The porous film 3 containing these materials, which is excellent in heat resistance and is electrochemically stable, can effectively prevent internal short-circuit from being caused. Methods of printing a porous film slurry may include gravure printing, screen printing, and the like, for example.

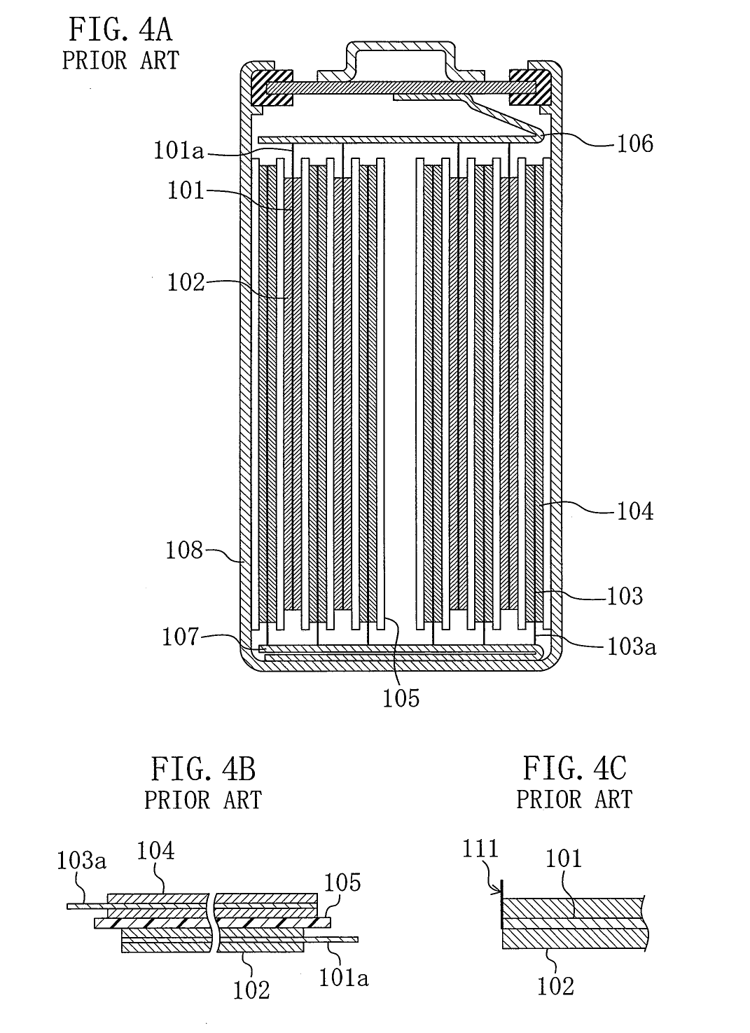

Similarly to the conventional secondary battery having the tab-less structure shown in FIG. 4(a), a electrode assembly having the structure shown in FIG. 1 is accommodated in the battery casing, and the second non-formation part 1b of the negative electrode current collector 1 and the exposed part 5b of the positive electrode current collector 5 are bonded by welding or the like to the negative electrode current collector plate and the positive electrode current collector plate, respectively, to thus form a secondary battery.

In the present embodiment, the porous film 3 is formed only in the negative electrode. However, it may be formed on each of the negative electrode and the positive electrode, or only in the positive electrode, of course.

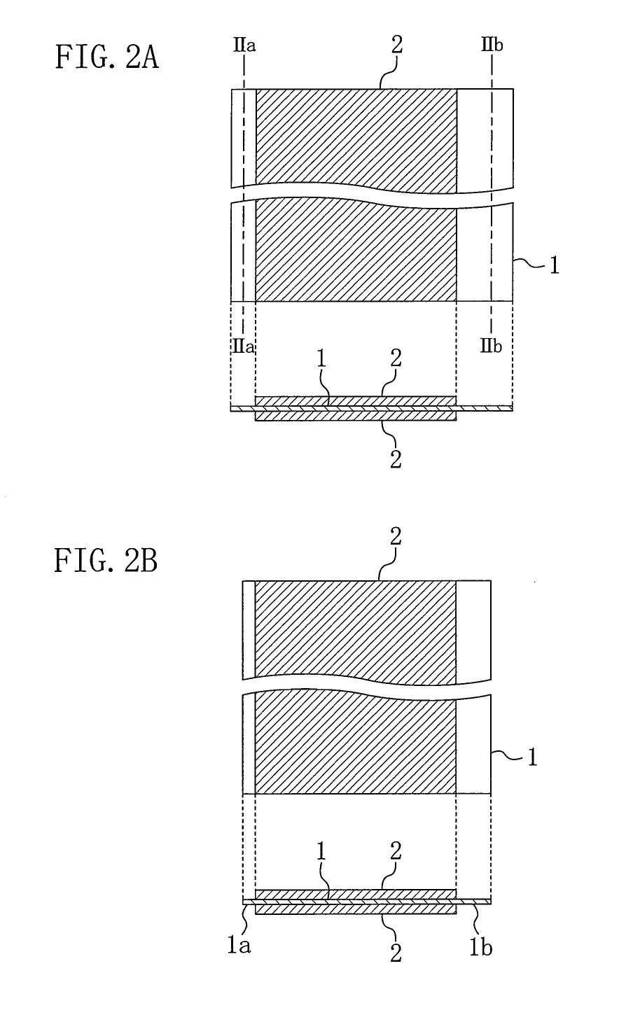

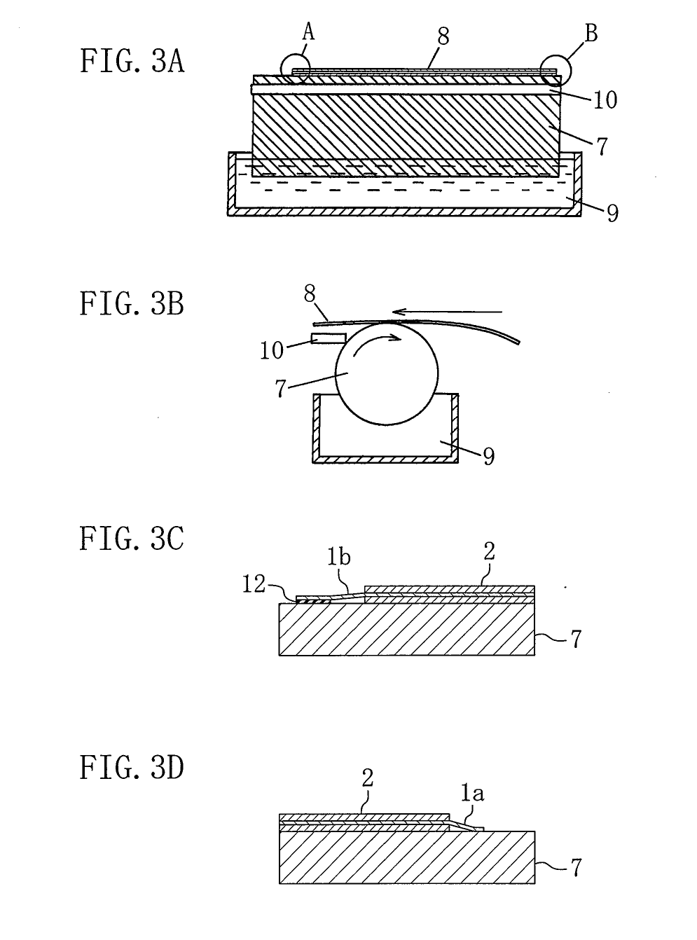

A method of producing an electrode for a secondary battery in accordance with the present embodiment will be described with reference to FIGS. 2(a) to 2(b) and FIGS. 3(a) to 3(d). In this embodiment, the negative electrode is referred to as an example.

First of all, as shown in FIG. 2(a) (the upper part presents a plan view while the lower part presents a sectional view; the same is applied to FIG. 2(b)), the negative electrode active material layer 2 is formed on each surface of the negative electrode current collector 1 so that the respective end parts thereof are exposed. The negative electrode active material layer 2 can be formed, for example, by applying a slurry containing a negative electrode active material, such as graphite or the like onto the negative electrode current collector 1.

Next, as shown in FIG. 2(b), each active material layer non-formation part at the end parts of the negative electrode current collector 1 on which the negative electrode active material layer 2 is not formed is cut along the lines IIa-IIa and IIb-IIb. In cutting, the width of the first non-formation part 1a at one of the end parts of the negative electrode current collector 1 is formed narrower than that of the second non-formation part 1b at the other end part thereof.

Subsequently, the porous film is formed on the negative electrode current collector 1 having the surfaces on each of which the negative electrode active material layer 2 is formed (hereinafter referred to it as a “negative electrode plate 8”) to cover the negative electrode active material layer 2. The porous film can be formed by, for example, an ordinary gravure printing, as shown in FIGS. 3(a) and 3(b). Herein, FIG. 3(a) is a side sectional view of a gravure printing apparatus, and FIG. 3(b) is a front sectional view of the same apparatus.

As shown in FIGS. 3(a) and 3(b), a gravure roll 7 having a peripheral surface in which a plurality of trenches are formed is place so that the underneath part of the peripheral surface thereof is dipped in the porous film slurry retained in a liquid tank 9. When the gravure roll 7 is revolve in the reverse direction to the running direction of the negative electrode plate 8 with it being in contact with the running negative electrode plate 8, the porous film slurry supplied to the trenches of the gravure roll 7 can be transcribed onto the surface of the negative electrode plate 8. The porous film slurry transcribed on the surface of the negative electrode plate 8 is then dried.

FIGS. 3(c) and 3(d) are enlarged views showing the sates of the end parts A, B of the negative electrode plate 8. As shown in FIG. 3(d), the narrow first non-formation part 1a is in contact with the gravure roll 7 to form the porous film (not shown) additionally on an edge surface of the active material layer 2.

Referring to FIG. 3(c), a tape 12 is attached to a part of the wide second non-formation part 1b which includes the tip end thereof, so that a region where the porous film is not formed (to be bonded to a current collector plate) can be formed at the part of the second non-formation part 1b. Alternatively, the region where the porous film is not to be formed can be formed by allowing the gravure roll 7 not to come in contact with the region or by forming the trenches in a region of the gravure roll 7, which will come in contact with the region, deeper than those in the other region.

When the trenches are formed so as to be inclined with respect to the peripheral surface of the gravure roll 7 under adjustment of the direction and/or angle of the inclination, the thickness of the porous film formed at the edge surfaces of the active material layer 2 at the first non-formation part 1a can be optimized.

A scraping blade 10 in the figure is provided along the gravure roll 7 for scraping surplus part of the porous film slurry adhering to the surface of the gravure roll 7 other than the trenches.

The positive electrode, the negative electrode, and the separator composing the secondary battery in accordance with the present invention may be made of the following materials, and may be produced by the following producing methods.

Example materials of the positive electrode active material layer may include complex oxides, such as lithium cobaltate and its denatured substances (eutectics of aluminum, magnesium and the like), lithium nickelate and its denatured substances (products obtained by substituting part of nickel thereof by cobalt, aluminum, or the like), lithium manganate and its denatured substances, and the like. As a conductor, one of acetylene black, ketjen black, and various kinds of graphite, or any combination thereof may be added. As a binder, polytetrafluoroethylene (PTFE), polyvinylidene difluoride (PVdF), or the like may be added.

These materials are kneaded with water or an organic solvent in a kneader with a thickener added as needed to prepare a positive electrode mixture slurry. Then, the thus prepared slurry is applied onto an aluminum current collector by a die coater or the like and is then dried to form an active material layer on the current collector. Herein, a non-formation part on which the positive electrode active material layer is not formed is formed continuously at each end part in the longitudinal direction of the positive electrode plate. Thereafter, pressing is carried out as needed. In the case where the porous film is formed thereon, the positive electrode plate is slit so that one of the remaining non-formation parts has a width necessary for serving as the formation margin for the porous film to thus prepare a base material of the positive electrode.

The negative electrode active material may be made of any of various kinds of natural graphite, artificial graphite, and alloy composition materials. The binder may be made of styrene-butadiene rubber (SBR), polyvinylidene difluoride (PVdF), or the like.

These material are kneaded with water or an organic solvent in a kneader with a thickener added as needed to prepare a negative electrode mixture slurry. Then, the thus prepared slurry is applied onto a copper current collector by a die coater or the like, and is then dried to form an active material layer on the current collector. Herein, a non-formation part in which the negative electrode active material layer is not formed is formed continuously at each end part in the longitudinal direction of the negative electrode plate. Thereafter, pressing is carried out as needed. In the case where the porous film is formed thereon, the active material layer is slit so that one of the remaining non-formation parts has a width necessary for serving as the formation margin for the porous film to thus prepare a base material of the negative electrode.

As a separator, a micro-porous film high in electrolyte retention and stable under each potential of the positive electrode and the negative electrode may be employed. The separator may be made of any of polypropylene, polyethylene, polyimide, poliamide, and the like, for example.

With the separator interposed, the positive electrode and the negative electrode prepared by the above methods are wound, or these components are processed into the necessary dimension and are stacked, thereby producing an electrode assembly. Then, the current collector parts exposed at the respective ends of the electrode assembly are welded to the current collector plates connected to the external terminals, and then, the electrode assembly is inserted into the battery casing. After nonaqueous electrolyte is injected thereinto, a necessary part is sealed, thereby obtaining a secondary battery. The shape of the battery may be, but not be limited to, cylindrical or rectangular shape.

The present invention will be described further in detail below by referring to examples.

### Example 1

A positive electrode producing method will be described. To an aqueous solution of NiSO₄, a sulfate of Co and Al at a predetermined ratio was added to prepare a saturated aqueous solution. While the saturated aqueous solution was stirred, an alkaline solution in which the sodium hydroxide is dissolved was dropped at a slow pace for neutralization, thereby generating a precipitate of a ternary nickel hydroxide, Ni_{0.7}CO_{0.2}Al_{0.1}(OH)₂ by coprecipitation. This precipitate was filtered, was washed with water, and was dried at a temperature of 80° C. The thus obtained nickel hydroxide had an average particle diameter of approximately 10 μm.

Thereafter, the obtained Ni_{0.7}CO_{0.2}Al_{0.1}(OH)₂ was subjected to a heat treatment in the air at a temperature of 900° C. for ten hours to obtain nickel oxide, Ni_{0.7}CO_{0.2}Al_{0.1}O. Hydrated lithium hydroxide was added thereto so that the sum of each number of the atoms of Ni, Co, and Al is equal to the number of the atoms of Li, and a heat treatment was carried out in dry air at a temperature of 800° C. for ten hours, thereby obtaining a complex oxide of lithium and nickel expressed by the compositional formula of LiNi_{0.7}CO_{0.2}Al_{0.1}O₂ as a positive electrode active material. After crushing and classification, positive electrode material powder was obtained. The average particle diameter and the specific surface area thereof were 9.5 μm and 0.4 m²/g, respectively.

The thus obtained complex oxide of lithium and nickel of 3 kg, acetylene black of 90 g, and a PTFE dispersed liquid (60% solid part) of 100 g were kneaded with water of an appropriate weight to prepare a positive electrode slurry. This slurry was applied onto an aluminum foil of 15 μm in thickness and 150 mm in width to form continuously an applied part of 110 mm in width, a non-formation part of 11 mm at one end part in the longitudinal direction of the foil, and a non-formation part of 29 mm at the opposite end part thereof, and was then dried. After pressing the thus formed intermediate to have a total thickness of 100 μm, it was slit so that: the width of the electrode plate is 124 mm; the width of the applied mixture is 110 mm; the width of one non-applied side part is 11 mm; and the width of the opposite non-applied side part serving as the formation margin for the porous film is 3 mm, thereby obtaining a positive electrode.

A method of producing a negative electrode will be described next. Artificial graphite of 3 kg, a rubber particle binder of styrene-butadiene copolymer (40 weight % solid part) of 75 g, carboxymethyl cellulose (CMC) of 30 g, and water of an appropriate weight were kneaded to prepare a negative electrode slurry. This slurry was applied onto a copper foil of 10 μm in thickness and 150 mm in width to form continuously an applied part of 114 mm in width, a non-formation part of 11 mm at one end part in the longitudinal direction of the foil, and a non-formation part of 25 mm at the opposite end part thereof, and was then dried. After pressing the thus obtained intermediate to have a total thickness of 110 μm, it was slit so that: the width of the electrode plate is 128 mm; the width of the applied mixture is 114 mm; the width of one non-applied side part is 11 mm; and the width of the opposite non-applied side part serving as the formation margin for the porous film is 3 mm, thereby obtaining a negative electrode.

A method of producing a porous film slurry will be described next. Alumina of 1000 g having a median diameter of 0.3 μm was kneaded with a polyacrylonitrile denatured rubber binder (8 weight % solid part) of 375 g and an appropriate amount of NMP solvent to produce a porous film slurry.

As an apparatus for forming a porous film, a gravure coater was used. The porous film slurry was continuously applied onto a part of the 11 mm non-formation part on one of the sides of the positive electrode which ranges from the active material layer end part to a point 6 mm outside therefrom to form an external current collecting exposed part having a width of 5 mm and a porous film covering one of the mixture end parts. As to the porous film formation margin having a width of 3 mm on the opposite side thereto, the porous film slurry was applied entirely. Thus, the porous film slurry was applied onto each end part and the entire flat surface of the active material layer. Thereafter, the solvent in the slurry was dried by a continuously formed drying furnace. Subsequently, the porous film slurry was applied onto the other surface of the positive electrode by the same manner, and was then dried. As a result, the porous film was formed on the flat face parts and the entire edge surfaces of the end parts of the positive electrode mixture to thus form a positive electrode plate including a current collecting exposed part having a width of 5 mm on one of the end parts thereof. The porous film was formed by gravure printing so that the thickness thereof on the active material layer is approximately 10 μm. In this example, the porous film was not formed on the negative electrode.

The positive electrode in which the porous film is thus applied, and the negative electrode in which the porous film is not formed were wound into a rectangular shape with a polyethylene separator interposed therebetween so that the positive and negative electrode current collectors are exposed at the respective end parts thereof, thereby obtaining an electrode assembly. External current collector terminals were resistance welded to the ends of the electrode assembly. This electrode assembly was inserted into a rectangular aluminum casing so that the terminals are protruded in the opposite directions. All part of the casing other than the liquid cock was sealed. An electrolyte was injected into the casing. The electrolyte has been prepared by dissolving lithium hexafluopohshpate (LiPF₆) at a density of 1 mol/dm3 as a solute into a mixed solvent obtained by mixing ethylene carbonate (EC) and ethyl methyl carbonate (EMC) at a volume ratio of 1:3. Finally, the liquid cock was sealed to thus obtain a secondary battery having a nominal capacity of 5 Ah. In order to prevent breakage by internal pressure rise in the battery, the casing was arranged to include a safety valve that opens at ten atmospheric pressures.

### Example 2

Except formation of the porous film in the negative electrode rather than in the positive electrode in Example 1, a battery was produced by the same method as in Example 1. The thus produced battery is called a battery B.

### Example 3

The porous film was formed in the negative electrode by the same manner as in the positive electrode in Example 1 to thus form the porous film in both the positive electrode and the negative electrode. Except this, a battery was produced by the same manner as in Embodiment 1. The thus produced battery is called a battery C.

### Comparative Example 1

The positive electrode in Example 1 on which the porous film had not been formed yet was slit into a form having an electrode plate width of 121 mm, a mixture applied width of 110 mm, a non-applied width of 11 mm on one side without leaving the non-applied width of 3 mm on the opposite side. The porous film was then formed thereon. At this time point, the porous film was not formed on the end part of the positive electrode mixture opposite the current collector part. On the other hand, the negative electrode in Example 1 on which the porous film had not been formed yet was slit into a form having an electrode plate width of 125 mm, a mixture applied width of 114 mm, a non-applied width of 11 mm on one side without leaving the non-applied width of 3 mm on the opposite side. A battery was produced by the same manner as in Example 1 except the above. The thus produced battery is called a battery D. The porous film was not formed on the end part of the positive electrode mixture opposite the current collector part.

### Comparative Example 2

A battery was produced by the same manner as in Comparative Example 1 except formation of the porous film in the negative electrode rather than formation thereof in the positive electrode as in Comparative Example 1. The porous film was not formed on the end part of the negative electrode active mixture layer opposite the current collector part. The thus produced battery is called a battery E.

### Comparative Example 3

A battery was produce by the same manner as in Comparative Example 1 with the use of the positive electrode in Comparative Example 1 and the negative electrode in Comparative Example 2 each having an electrode plate on which the porous film was not formed. The thus produced battery is called a battery F.

### Comparative Example 4

A battery was produced by the same manner as in Example 1 except non-formation of the porous film in the positive electrode in Example 1. The thus produced battery is called a battery G.

Each 20 batteries were produced as the above named batteries. The thus obtained batteries of each example were evaluated by the following manners.

(Short-Circuit Test)

Once an external terminal was resistance welded to the positive electrode of an electrode assembly, a voltage of 250 V was applied to the respective ends of terminals to check the presence or absence of a leakage current at that time as short-circuit in the electrode assembly. Subsequently, an external terminal was resistance welded to the negative electrode in an electrode assembly in which short-circuit had not been caused in the previous test, and the same short-circuit test was carried out thereon.

(Crushing Test)

Once an electrode assembly of which abnormality was observed in the above short-circuit tests was assembled to a battery, three-cycle charge and discharge was carried out on the battery at a current of 1.4 A and within the voltage range between 3 and 4.2 V under an environment of 25° C., and then, the battery capacity was checked. Thereafter, the battery was charged up to an overcharge of 4.4 V at the same current. Then, crushing was carried out under an environment at a temperature of 25° C. with the use of a plate having a tip end processed into a circular shape of 8 mm in diameter to crush a battery 1) from the casing edge surface on the side of the positive electrode terminal to the depth of 10 mm; 2) from the casing edge surface on the side of the negative electrode terminal to the depth of 10 mm; and 3) from the centre line part of the surface where the positive electrode and the negative electrode terminal are respectively positioned right and left to a depth of ½ of the battery in the thickness direction. Each two batteries were subjected to the tests 1) to 3). Overcharge at 4.4 V was carried out for further clarifying heat generation behavior of the batteries at crushing.

Table 1 indicates each example battery and evaluation results thereof. All the batteries had a nominal capacity of around 5 Ah as the battery capacity. As to the crushing tests, the results of each one of two batteries of each example which was higher in battery reaching temperature is indicated.

TABLE 1

| | Current | | Short-circuit test after terminal | | | | |
|---|---|---|---|---|---|---|---|
| | collector | | welding | | Maximum reaching temperature | | |
| | exposed | | Number of | Number of | in crushing test | | |
| | part at each | | occurrences | occurrences on | | 2) Negative | |
| | electrode | | on positive | negative | 1) Positive | electrode | |
| Battery No. | plate end | Porous film | electrode side | electrode side | electrode side | side | 3) Central part |
| A | Present | Positive | 0 | 0 | 75° C. | 27° C. | 32° C. |
| | | electrode | | | | | |
| B | Present | Negative | 0 | 0 | 28° C. | 38° C. | 28° C. |
| | | electrode | | | | | |
| C | Present | Both | 0 | 0 | 26° C. | 28° C. | 26° C. |
| D | Absent | Positive | 0 | 0 | 128° C. | 36° C. | 31° C. |
| | | electrode | | | (valve opened) | | |
| E | Absent | Negative | 0 | 0 | 137° C. | 33° C. | 29° C. |
| | | electrode | | | (valve opened) | | |
| F | Absent | None | 2 | 3 | 122° C. | 52° C. | 148° C. |
| | | | | | (valve opened) | | (valve opened) |
| G | Present | None | 6 | 4 | 79° C. | 36° C. | 150° C. |
| | | | | | | | (valve opened) |

Examination will be given on the results in Table 1.

Referring first to the electrode assembly of the battery G in which short-circuit was recognized after welding the external terminal, it was found that: with no porous film formed on the mixture surface, the separator was shrunk or melt by heat at welding to allow the opposed electrode plates to be exposed. This might have caused the short-circuit. As to the crushing test on the positive electrode side 1), it is inferred that short-circuit was caused in the positive electrode current collector with the end part of the negative electrode current collector, and partial short-circuit with the negative electrode active material layer was caused in addition. It should be noted that it has been evident that the short-circuit current between the positive electrode aluminum foil and the negative electrode carbon active material layer is large and the active material layer exhibits high serf-heating. From these factors, it is inferred that the maximum reaching temperature was 36° C. in the negative electrode side crushing 2) while that was 79° C. in the positive electrode side crushing 1) because partial short-circuit between the positive electrode aluminum and the negative electrode carbon active material layer coincide therewith. In the central part crushing 3), short-circuit was immediately caused between the positive electrode and the negative electrode, and the area thereof was wide. Accordingly, remarkably high heat generation at 150° C. was recognized. Behavior that the safety valve was opened was observed, which might be caused due to internal pressure rise by liquefaction of the electrolyte.

Referring next to the batteries D to F, the positive electrode side crushing 1) caused short-circuit ranging wide between the positive electrode aluminum foil and the end part of the negative electrode active material layer on which the porous film is not formed to result in high heat generation. This resulted in recognition of heat generation over 120° C. and safety valve opening. In the battery F in which the porous film is not formed, short-circuit was caused in welding the current collector external terminal.

In contrast to the above Comparative Examples, the batteries A to C includes the porous film in at least one of the positive electrode and the negative electrode to result in no observation of short-circuit at welding the current collector terminal. Referring to the battery A, in the positive electrode side crushing 1), it is inferred that short-circuit was caused in the positive electrode current collector with the end part of the negative electrode current collector, and partial short-circuit was caused in the negative electrode active material layer, similarly to the battery G. As a result, it was inferred that heat generation at 75° C. was caused because of the factors mentioned in the result of the battery G. Referring to the batteries B and C, no significant heat generation was recognized in all the crushing tests 1) to 3).

The above results prove that in a secondary battery in which a positive electrode and a negative electrode each having a current collector on which an active material layer is arranged are stacked or wound, by covering with the porous film the edge surfaces of the active electrode material layer at the end parts of the current collector in at least one of the positive electrode and the negative electrode, internal short-circuit can be suppressed, and the safety at internal short-circuit by pressure from the outside of the battery can be increased. Preferably, provision of the porous film in the negative electrode can obtain a further safety secondary battery.

The present invention has been described with reference to the preferred embodiments, but the present description does not serve as any limitation. Various kinds of modifications are possible, of course.

It is noted that the “active material layer” in the present invention means a layer including at least an active material, and there is no question of containing any material other than the active material, such as a binder, a conductor, a thickener, and the like.

### INDUSTRIAL APPLICABILITY

The present invention is useful for a highly safety tab-less electrode and a secondary battery including it, and is applicable to power sources for driving note PCs, mobile phones, digital still cameras, electronic power tools, electric automobiles, and the like

1-13. (canceled)

14. A method of producing an electrode for a secondary battery, composing an electrode assembly in which a positive electrode and a negative electrode are wound or stacked with a separator interposed therebetween, comprising:
a step (a) of forming an active material layer on a current collector so as to expose respective end parts of the current collector; and
a step (b) of forming a porous film on the current collector so as to cover the active material layer by applying a porous film slurry by gravure printing,
wherein, in the step (a), a first active material layer non-formation part at one of the end parts of the current collector is narrower in width than a second active material layer non-formation part at the other end part thereof,
in the step (b), the porous film is formed to cover an edge surface of the active material layer at the first active material layer non-formation part while exposing a part of the second active material layer non-formation part of the current collector, and
the electrode formed through the steps (a) and (b) is used as at least one of the positive electrode and the negative electrode composing the electrode assembly, and an end part of the second active material layer non-formation part is bonded to a current collector plate connected to an electrode terminal.

15. The method of claim 14, wherein
in the step (b), the porous film is formed so as to cover the entirety of the first active material layer non-formation part.

16. The method of claim 14, wherein
the step (a) includes:
a step (a1) of forming the active material layer on the current collector so as to expose respective end parts of the current collector up to arbitrary widths; and
a step (a2) of cutting the respective end parts of the current collector so that the first active material layer non-formation part at one of the end parts of the current collector is narrower in width than the second active material layer non-formation part at the other end part thereof.

17. The method of claim 14, wherein
in the step (a), the active material layer is formed so that the first active material layer non-formation part has a width of 3 mm or smaller, while the second active material layer non-formation part has a width of 5 mm or larger.

18. The method of claim 14, wherein
the porous film contains an inorganic oxide.

19. The method of claim 14, wherein
the electrode is used as a negative electrode.

20. A secondary battery comprising a positive electrode and a negative electrode, at least one of which is produced by the method of claim 14, wherein
the electrode composes an electrode assembly in which the positive electrode and the negative electrode are wound or stacked with a separator interposed therebetween, and
an end part of the second active material layer non-formation part of the current collector is bonded to a current collector plate connected to an electrode terminal.

21. A secondary battery comprising an electrode assembly in which a positive electrode and a negative electrode, in each of which an active material layer is formed on a current collector, are wound or stacked with a separator interposed therebetween, wherein
a porous film applied by gravure printing to cover the active material layer is formed on the current collector of at least one of the positive electrode and the negative electrode,
the current collector on which the porous film is formed includes at respective ends thereof a first active material layer non-formation part and a second active material layer non-formation part on each of which the active material layer is not formed,
the first active material layer non-formation part is narrower in width than the second active material layer non-formation part,
an edge surface of the active material layer at the first active material layer non-formation part is covered with the porous film,
a part of the second active material layer non-formation part of the current collector is not covered with the porous film and
an end part of the second active material layer non-formation part is bonded to a current collector plate connected to an electrode terminal.

22. The secondary battery of claim 21, wherein
all part of the first active material layer non-formation part of the current collector is covered with the porous film.

23. The secondary battery of claim 21, wherein
the first active material layer non-formation part has a width of 3 mm or smaller, while the second active material layer non-formation part has a width of 5 mm or larger.

24. The secondary battery of claim 21, wherein
the porous film contains an inorganic oxide.

25. The secondary battery of claim 21, wherein
the current collector on which the porous film is formed serves as a negative electrode current collector.

26. A secondary battery comprising a positive electrode and a negative electrode, at least one of which is produced by the method of claim 15, wherein
the electrode composes an electrode assembly in which the positive electrode and the negative electrode are wound or stacked with a separator interposed therebetween, and
an end part of the second active material layer non-formation part of the current collector is bonded to a current collector plate connected to an electrode terminal.

27. A secondary battery comprising a positive electrode and a negative electrode, at least one of which is produced by the method of claim 16, wherein
the electrode composes an electrode assembly in which the positive electrode and the negative electrode are wound or stacked with a separator interposed therebetween, and
an end part of the second active material layer non-formation part of the current collector is bonded to a current collector plate connected to an electrode terminal.
